(19) United States
(12) Patent Application Publication
(10) Pub. No.: US 2025/0018744 A1
(43) Pub. Date: Jan. 16, 2025

(54) CASTER ASSEMBLY

(71) Applicant: DRYFT BOARD LLC, Los Angeles, CA (US)

(72) Inventors: Ralph Zipper, Melbourne, FL (US); Robert Glashan, Hollister, CA (US)

(21) Appl. No.: 18/352,993

(22) Filed: Jul. 14, 2023

(51) Int. Cl. B60B 33/00

(52) U.S. Cl. CPC B60B 33/006; B60B 33/0002

(57) ABSTRACT

Embodiments of the invention are directed to caster assemblies for providing mobility and facilitating movement of objects. The caster assemblies include a swivel assembly secured to a wheel assembly, the swivel assembly allowing the wheel of the caster assembly to rotate in clockwise and counterclockwise directions. A locking mechanism, having a sliding member, in the swivel assembly engages with one or more holes in a novel cam for limiting a rotation range of the cam, the sliding member configured to engage and disengage the one or more holes in the cam.

### TECHNICAL FIELD

The present disclosure generally relates to caster assemblies and, more particularly, to a caster assembly having a novel cam for limiting the rotational movement of the caster wheel.

### BACKGROUND

A caster assembly is a component widely used for to provide rolling support for a variety of objects including carts, trolleys, moving dollies, convertible hand trucks, tool chests, hydraulic floor jacks, appliances, chairs, stools, bed frames, and other types of equipment that require mobility. The caster assembly typically consists of four components: the caster wheel, the mounting plate, and the swivel.

The caster wheel is the part of the assembly that comes into contact with the ground and provides mobility. Caster wheels come in a variety of sizes, materials, and designs to suit different applications and environments. The mounting plate is the component that connects the caster wheel to the equipment. It is typically attached to the bottom of the equipment and provides a secure and stable connection between the equipment and the caster wheel.

The swivel is the part of the caster assembly that allows the caster wheel to rotate freely and change direction. The swivel typically includes a bearing and a cam. The swivel is usually positioned between the mounting plate and the caster wheel and can be locked or unlocked to control the movement of the equipment.

The brake is an optional component that can be added to the caster assembly to prevent the equipment from rolling when it is not in use. The brake is typically a lever or pedal that engages a mechanism to hold the caster wheel in place.

### BRIEF SUMMARY

The following presents a simplified summary of one or more aspects of the present disclosure to provide a basic understanding of such aspects. This summary is not an extensive overview of all contemplated features of the disclosure. It is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description presented below.

In one example, a caster assembly is provided. The caster assembly includes a mounting base attachable to a movable device; a swivel assembly located within the mounting base; and a wheel. The swivel assembly comprises a cam having one or more holes or cut outs; a locking mechanism having a sliding member for engaging with the one or more holes or cutouts in the cam for limiting a rotation range of the cam, the sliding member configured to engage and disengage the one or more holes or cutouts in the cam; the size of the holes or cutouts and the size of the sliding member such that the difference between the width of the one or more holes or cut outs and width of the sliding member is set to limit the axial rotation of a yolk to a desired angle; and a yoke pivotally, fixably connected to the cam, the yoke comprising a central section and two arms extending from opposite ends of the central section. The wheel is mounted between the two arms of the yoke.

According to one aspect, the sliding member comprises a main body having a support arm integrally connected to, and extending outward from, the main body, the main body and the support arm located within the same horizontal plane.

According to another aspect, the rotation range of the cam is limited by a distance between a surface of the support arm and edges of the one or more holes or cutouts in the cam.

According to yet another aspect, the distance is selected to limit the rotation range of the cam to 0 to 15 degrees. According to yet another aspect, the distance is selected to limit the rotation range of the cam to 0 to 45 degrees. According to yet another aspect, the distance is selected to limit the rotation range of the cam to 0 to 60 degrees. According to yet another aspect, the distance is selected to limit the rotation range of the cam to 0 to 270 degrees. According to yet another aspect, the distance is selected to limit the rotation range of the cam to of the cam to 0 to 10 degrees.

According to yet another aspect, the locking mechanism includes a ball detent mechanism that selectively inhibits axial movement of the sliding member.

In another example, a caster assembly is provided. The caster assembly includes a mounting base attachable to a movable device; a swivel assembly located within the mounting base; and a wheel. The swivel assembly comprises a cam having one or more holes or cutouts; and a locking mechanism having a sliding member for engaging with the one or more holes or cutouts in the cam for limiting a rotation range of the cam, the sliding member configured to engage and disengage the one or more holes or cutouts in the cam; and a yoke pivotally, fixably connected to the cam, the yoke comprising a central section and two arms extending from opposite ends of the central section. The wheel is mounted between the two arms of the yoke.

In yet another example, a caster assembly is provided. The caster assembly includes a mounting base attachable to a movable device; a swivel assembly located within the mounting base; and a wheel. The swivel assembly comprises a cam having one or more holes or cutouts; and a locking mechanism having a sliding member for engaging with the one or more holes or cutouts in the cam for limiting a rotation range of the cam, the sliding member operable between a first locked position, an unlocked position, and a second locked position; and a yoke pivotally, fixably connected to the cam, the yoke comprising a central section and two arms extending from opposite ends of the central section. The wheel is mounted between the two arms of the yoke.

According to one aspect, the sliding member comprises a first elongated protrusion and a second elongated protrusion integrally connect to, and separated by, a channel.

According to another aspect, the rotation range of the cam is limited by a distance between a surface of an inner portion of the first or second elongated protrusion and edges of the one or more holes or cutouts in the cam.

According to yet another aspect, the distance is selected to limit the rotation range of the cam to 0 to 15 degrees. According to yet another aspect, the distance is selected to limit the rotation range of the cam to 0 to 30 degrees. According to yet another aspect, the distance is selected to limit the rotation range of the cam to 0 to 45 degrees. According to yet another aspect, the distance is selected to limit the rotation range of the cam to 0 to 60 degrees. According to yet another aspect, the distance is selected to limit the rotation range of the cam to 0 to 270 degrees. According to yet another aspect, the distance is selected to limit the rotation range of the cam to 0 to 10 degrees.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 illustrates a bottom, front, right perspective view of a caster assembly, according to one aspect.

FIG. 2 illustrates an exploded view of the caster assembly of FIG. 1.

FIG. 3 illustrates a bottom, front, left perspective view of the caster assembly of FIG. 1.

FIG. 4 illustrates a top, front, left perspective view of the caster assembly of FIG. 1.

FIG. 5 illustrates the caster assembly of FIG. 1 in an unlocked position.

FIG. 6 illustrates the caster assembly of FIG. 1 in a locked position.

FIG. 7 illustrates a cross-sectional view taken along line 7-7 of FIG. 5.

FIG. 8 illustrates a cross-sectional view taken along line 8-8 of FIG. 6.

FIG. 9 illustrates a bottom, front, right perspective view of a caster assembly, according to one aspect.

FIG. 10 illustrates a top, front, right perspective view of the caster assembly of FIG. 9.

FIG. 11 illustrates an exploded view of the caster assembly of FIG. 9.

FIG. 12 illustrates a top plan view of the caster assembly of FIG. 9 in a first locked position.

FIG. 13 illustrates a cross-sectional view taken along line 13-13 of FIG. 12.

FIG. 14 illustrates a top plan view of the caster assembly of FIG. 9 in an unlocked position.

FIG. 15 illustrates a cross-sectional view taken along line 15-15 of FIG. 14.

FIG. 16 illustrates a top plan view of the caster assembly of FIG. 9 in a second locked position.

FIG. 17 illustrates a cross-sectional view taken along line 17-17 of FIG. 16.

FIG. 18 illustrates a top, front, right perspective view of the caster assembly of FIG. 9 without the sliding member.

FIG. 19 illustrates a top plan view of the caster assembly of FIG. 18.

### DETAILED DESCRIPTION

In the following description, specific details are given to provide a thorough understanding of the described implementations. However, it will be understood by one of ordinary skill in the art that the implementations may be practiced without these specific details. For example, certain aspects may be illustrated with simplified representations in order not to obscure the implementations in unnecessary detail. In other instances, well-known techniques may be shown in broad block form in order not to obscure the described implementations.

### Terms

“Comprise” and variations, such as “comprising” and “comprises,” are not intended to exclude other additives, components, integers, or steps. “A″,” “an,” and “the” and similar referents used herein are to be construed to cover both the singular and the plural unless their usage in context indicates otherwise. The word “exemplary” is used herein to mean “serving as an example, instance, or illustration.” Any implementation or embodiment described herein as “exemplary” is not necessarily to be construed as preferred or advantageous over other embodiments or implementations. Likewise, “embodiments” does not require that all embodiments include the discussed feature, advantage, or mode of operation.

“Aspects” do not require that all aspects of the disclosure include the discussed features, advantages, or modes of operation. “Coupled” is used herein to means the direct or indirect coupling between two objects. For example, if object A physically touches or couples to object B, and object B touches or couples to object C, then objects A and C may still be considered coupled to one another, even if they do not directly physically touch each other.

The term “fastener” or “fastening member” may refer to any type of device for connecting metal, plastic, and other materials in common hardware construction, including screws, bolts, nuts, washers, rivets, cotter pins, clevis pins, studs, threaded rods, and other mechanical connectors.

The term “hole” may refer to any opening through a structure and/or component or a hollowed-out place in a structure and/or component, including apertures, bores, cavities, chambers, grooves, notches, passages, slits, and slots.

The term “protrusion” may refer to objects or parts projecting in an outward manner from a structure and/or component.

The term “moveable device” may refer to skateboard, roller skates, carts, trolleys, scooters, moving dollies, convertible hand trucks, tool chests, hydraulic floor jacks, appliances, chairs, stools, bed frames, and other types of equipment that require mobility.

The term “locking mechanism” may refer to any type of mechanism for limiting the rotation range of a cam, including but not limited to, a ball detent, coil spring, and a leaf spring.

### Overview

Embodiments of the invention are directed to caster assemblies for providing mobility and facilitating movement of objects. The caster assemblies include a swivel assembly secured to a wheel assembly, the swivel assembly allowing the wheel of the caster assembly to rotate in clockwise and counterclockwise directions. A locking mechanism, having a sliding member, in the swivel assembly engages with one or more holes in a novel cam for limiting a rotation range of the cam, the sliding member configured to engage and disengage the one or more holes in the cam.

Cam with Cut-Out

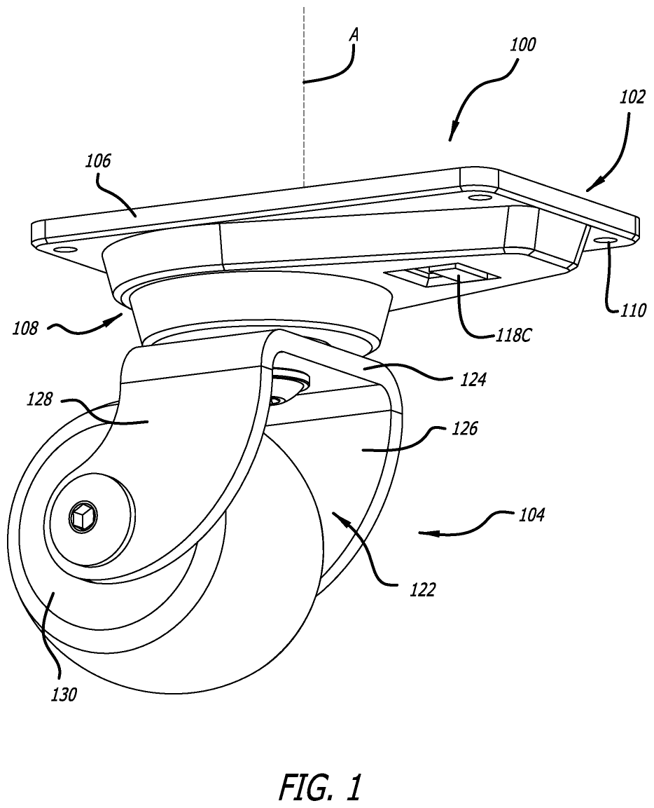

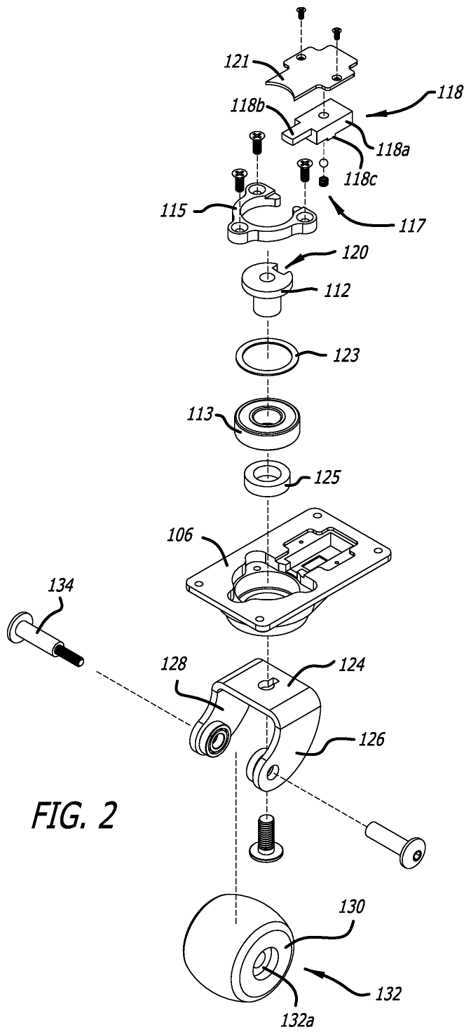

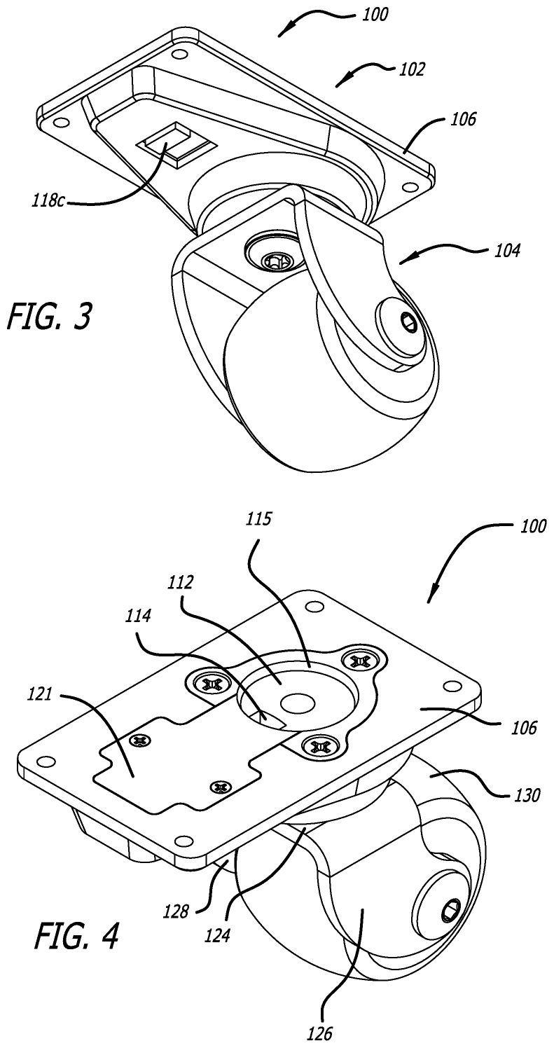

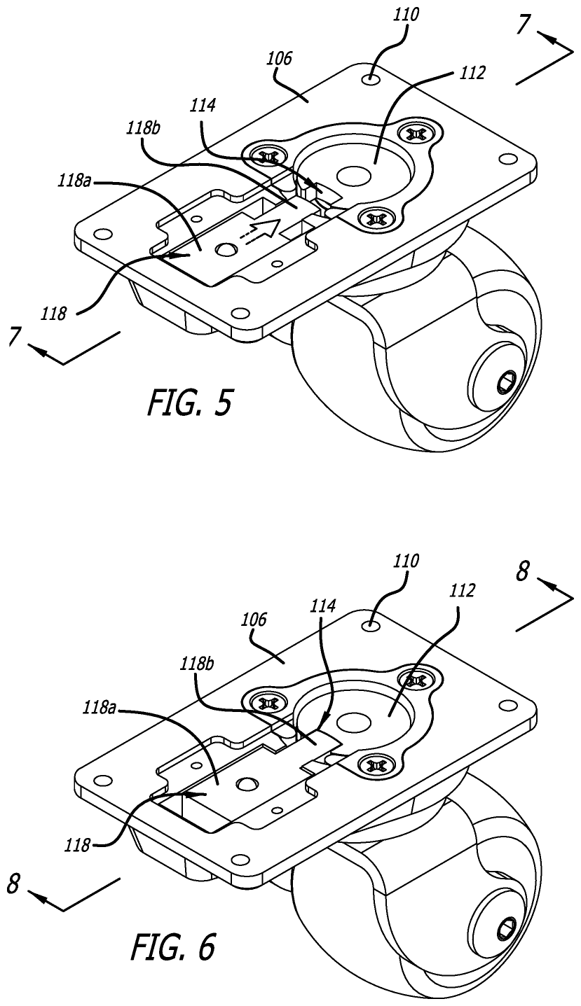

Referring now to FIGS. 1-7, a caster assembly 100 according to one aspect is provided. The caster assembly 100 includes a mounting base 102 and a wheel assembly 104. The mounting base 102, configured to support an object to be moved, includes a top mounting plate 106 having a generally planar upper surface and a swivel assembly 108. The top mounting plate 106 includes a plurality of holes 110 for coupling or mounting the top mounting plate 106 to an object, such as a board. Fasteners, such as threaded screws, pass through the plurality of holes 110 and thread into the object, such as a board, to secure the caster assembly 100 to the underside of the board.

The wheel assembly 104 includes a yoke 122 pivotally, fixably connected to the mounting base 102 for relative pivotal movement about a swivel axis ‘A’. The yoke 122 comprises a central section 124 and two arms 126, 128 extending downward from opposite ends of the central section 124. A wheel 130 is mounted between the first and second arms 126, 128 of the yoke 122.

The wheel 130 includes a hub 132 located at a central portion of the wheel 130 so that the inner diameter of the hub 132 corresponds to the inner diameter of the wheel 130. The hub 132 has a first end 132a located adjacent the first arm 126 of the yoke 122 and a second end 132b located adjacent the second arm 128 of the yoke 122. The first and second ends 132a and 132b of the hub 132 constitute the outermost side portions of the wheel 130. Bearings selected from any known in the art are preferably placed within the hub 132. An axle 134 extends through the hub 132 and any bearings to rotatably support the wheel 130 between the two arms 126, 128 of the yoke 122.

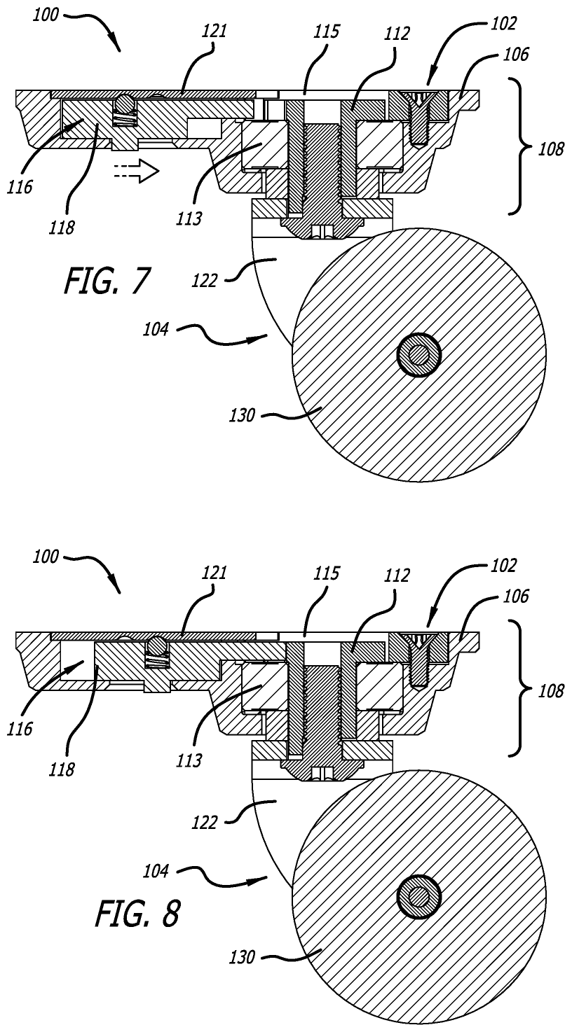

The swivel assembly 108, as shown in FIGS. 7 and 8, arranged at an upper end of the caster assembly 100, includes a top mounting plate 106 configured to be mounted to an equipment or a transport vehicle via a plurality of mounting holes 110 and fasteners (not shown), such as threaded fasteners. The swivel assembly 108 further includes a cam 112, fixedly attached to the central yolk section 124, and rotatably seated on a bearing 113 with the bearing 113 fixedly secured, preferentially press fit, within the mounting plate 106 that enables the cam 112 and yolk 122 to conjointly rotate, or “swivel,” relative to the top mounting plate 106 about the swivel axis A in first and second directions.

The swivel assembly 108 further includes a locking mechanism 116 having a ball detent mechanism 117 that selectively inhibits axial movement of a sliding member 118 for engaging with one or more holes or cut outs 114 in the cam 112 for limiting the rotational movement of the cam 112, the yolk 122 and the wheel 130 about the swivel axis A. In an exemplary embodiment, as shown in FIG. 4, the sliding member 118 includes a main body 118a having a support arm 118b integrally connected to, and extending outward from, the main body 118a, the main body 118a and the support arm 118b located within the same horizontal plane. The sliding member 118 further includes a protrusion 118c extending perpendicularly downward from the main body 118a, the main body 118a and the protrusion 118c located in different horizontal planes. The protrusion 118c is used for manually actuating the sliding member 118 between a first position and a second position, and the support arm 118b of the sliding member 118 positioned in planar alignment with a hole, holes, receiving groove, cut out or cut outs in the cam 112, such that moving of the sliding member from a first position to a second position causes the support arm 118b of the sliding member 118 to be received in the receiving groove or inside a portion of the hole or cut out in cam 112, thereby limiting the rotation or swivel of the cam 112, yolk 122, and wheel 130 to the distance, if any, between the surface of the support arm 118b and the edges of the hole or cut out 114. The distance may be deliberately set to limit axial rotation of cam 112, yolk 122, and wheel 130 to a specified range. By way of example, the distance may be set such that the cam 112, yolk 122, and wheel 130 can rotate only 30 degrees. In the preferred embodiments this distance would be set to prevent axial rotation. In alternative embodiments, the distance may be set to allow 0 to 10 degrees of axial rotation, 0 to 30 degrees of axial rotation, 0 to 45 degrees of axial rotation, 0 to 60 degrees of axial rotation, 0 to 270 degrees of axial rotation or any degree of axial rotation that is unreceivable to the user. When in the first, or locked, position, at least a portion of the support arm 118b is aligned with and received in the one or more holes or cut outs 114 of the cam 112 limiting the rotational movement of the cam 112 and the wheel 130. When in the second, or unlocked, position, the support arm 118b is not aligned with the one or more holes or cut outs 114 of the cam 112 allowing the cam 112, the yolk 122, and wheel 130 to rotate 360° in a clockwise or counterclockwise direction.

The swivel assembly 108 may further include a retainer ring 115 located within the top mounting plate 106 over the bearing 113 for securing the bearing 113 within the swivel assembly 108 and a cover plate 121 located within the top mounting plate 106 over the sliding member 118 for securing the sliding member 118 within the swivel assembly 108. The cover plate 121 and retainer ring 115 are preferably combined into a single part. A shim 123 may be located in the swivel assembly 108 to align the bearing 113 to ensure smooth swiveling, reduce friction, and enhance the caster assembly's overall performance. A standoff 125 may be utilized in the swivel assembly 108 to separate and provide distance between various components such as the wheel assembly 104 and the swivel assembly 108.

Cam with Multiple Cut-Outs

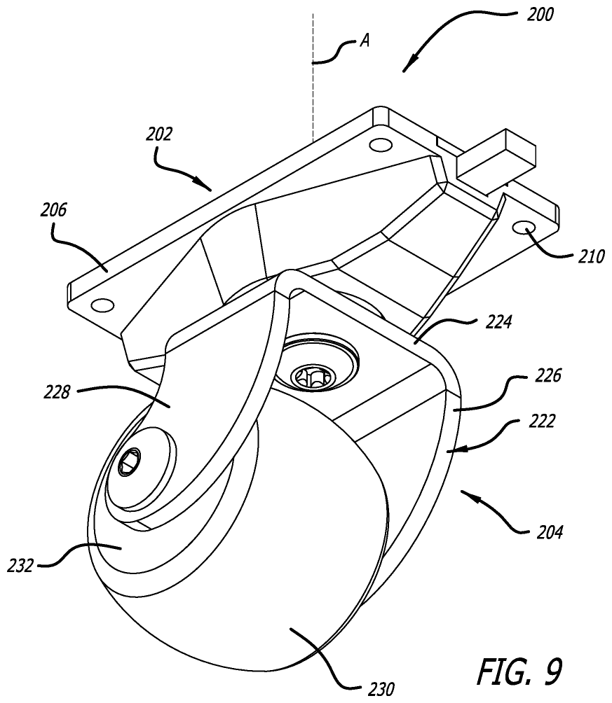

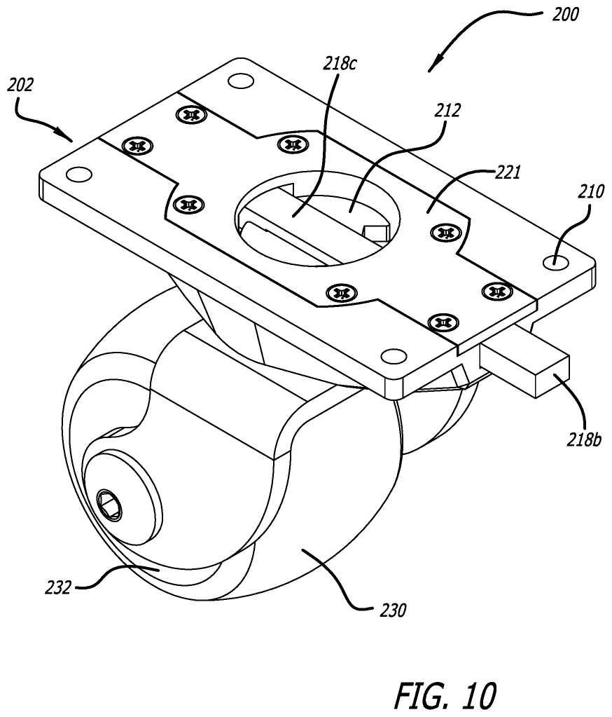

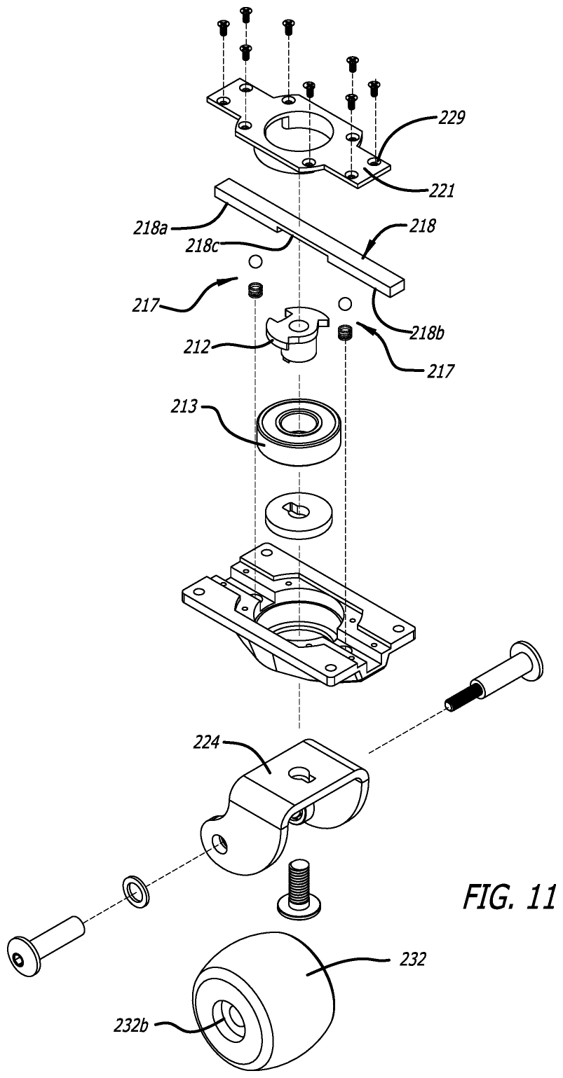

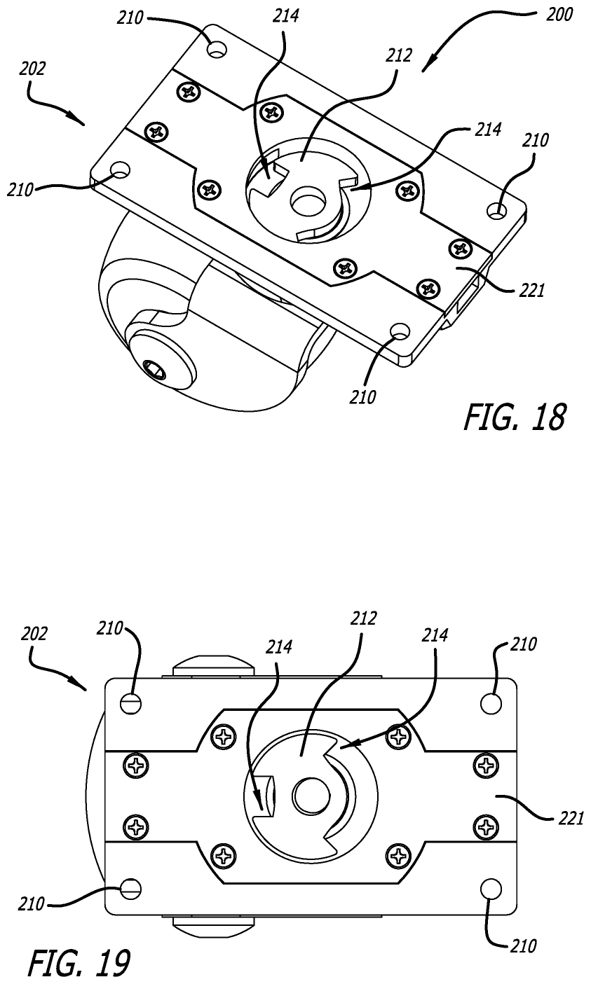

As shown in FIGS. 8-19, a caster assembly 200 according to another aspect is provided. The caster assembly 200 includes a mounting base 202 and a wheel assembly 204. The mounting base 202, configured to support an object to be moved, includes a top mounting plate 206 having a generally planar upper surface and a swivel assembly 208. The top mounting plate 206 includes a plurality of holes 210 for coupling or mounting the top mounting plate 206 to an object, such as a board. Fasteners, such as threaded screws pass through the plurality of holes 210 and thread into the object, such as a board, to secure the caster assembly 200 to the underside of the board.

The wheel assembly 204 includes a yoke 222 pivotally, fixably connected to the mounting base 102 for relative pivotal movement about a swivel axis ‘A’. The yoke 122 comprises a central section 224 and two arms 226, 228 extending downward from opposite ends of the central section 224. A wheel 230 is mounted between the first and second arms 226, 228 of the yoke 222.

The wheel 230 includes a hub 232 located at a central portion of the wheel 230 so that the inner diameter of the hub 232 corresponds to the inner diameter of the wheel 230. The hub 232 has a first end 232a located adjacent the first arm 226 of the yoke 222 and a second end 232b located adjacent the second arm 228 of the yoke 222. The first and second ends 232a and 232b of the hub 232 constitute the outermost side portions of the wheel 230. Bearings selected from any known in the art are preferably placed within the hub 232. An axle 234 extends through the hub 232 and any bearings to rotatably support the wheel 230 between the two arms 226, 228 of the yoke 222.

The swivel assembly 208, as shown in FIGS. 13, 15, and 17, arranged at an upper end of the caster assembly 200, includes a top mounting plate 206 configured to be mounted to an equipment or a transport vehicle via a plurality of mounting holes 210 and fasteners (not shown), such as threaded fasteners. The swivel assembly 208 further includes a cam 212, fixedly attached to the central yolk section 224, and rotatably seated on a bearing 213 with the bearing 213 fixedly secured, preferentially press fit, within the mounting plate 206 that enables the cam 212 and yolk 222 to conjointly rotate, or “swivel,” relative to the top mounting plate 206 about the swivel axis A in first and second directions.

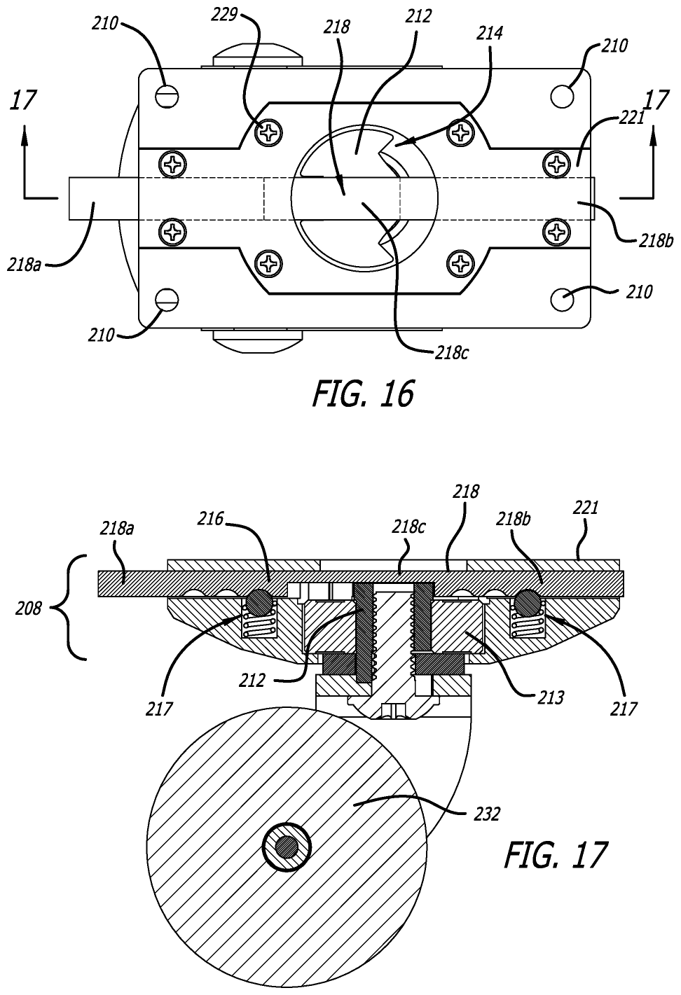

The swivel assembly 208 further includes a locking mechanism 216 having a ball detent mechanism 217 that selectively inhibits axial movement of a sliding member 218 for engaging with one or more holes, receiving grooves, or cut outs 214 in the cam 212 for limiting the rotational movement of the cam 212, the yolk 122 and the wheel 230 about the swivel axis A. The sliding member 218 includes a first elongated protrusion 218a and a second elongated protrusion 218b integrally connected to, and separated by, a channel 218c. The sliding member 218 is operable or moveable between three positions, a first locked position, an unlocked position, and a second locked position (See FIGS. 16-17).

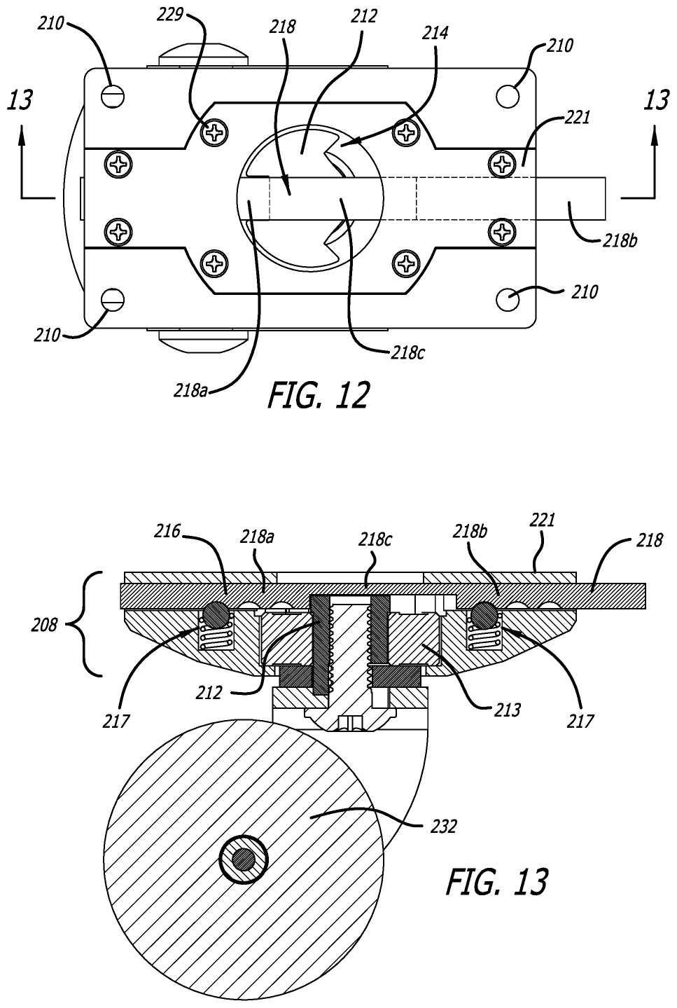

In the first locked position, as shown in FIGS. 12, 13, an inner portion of the first elongated protrusion 218a is received within the first receiving groove or inside a portion of the hole or cut out in cam 212 thereby limiting the rotation or swivel of the cam 212, yolk 222, and wheel 230 to the distance, if any, between the surface of the inner portion of the first elongated protrusion 218a and the edges of the hole or cut out 214. The distance may be deliberately set to limit axial rotation of the cam 212, yolk 222, and wheel 230 to a specified range. By way of example, the distance may be set such that the cam 212, yolk 222, and wheel 230 can rotate only 30 degrees. In the preferred embodiments this distance would be set to prevent axial rotation.

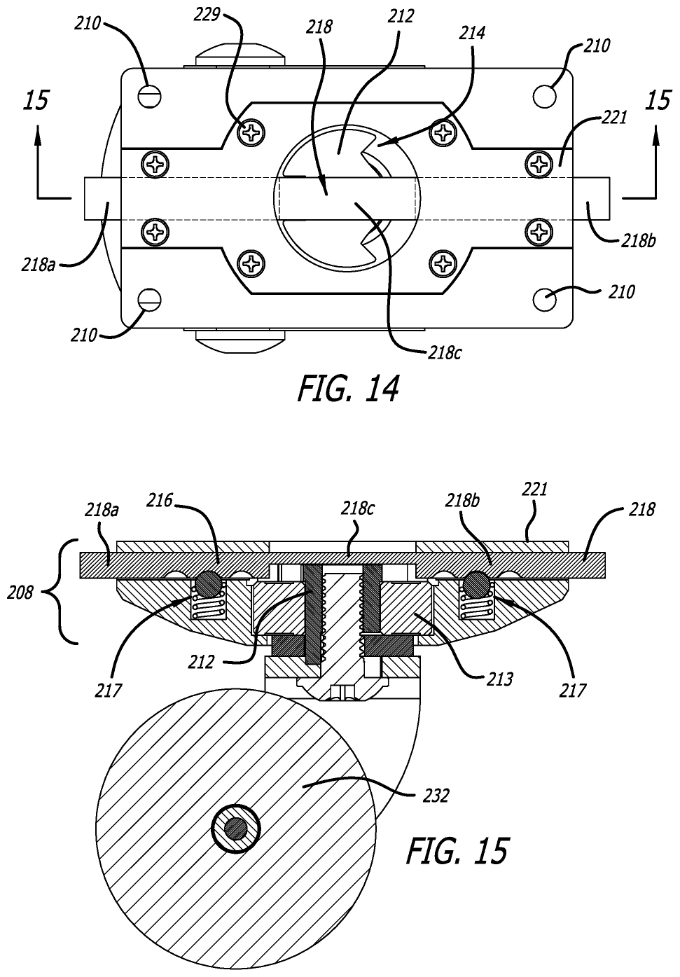

In the unlocked position, as is shown in FIGS. 14-15, the cam 212 is received within the channel 218c of the sliding member 218. The horizontal length of the channel 218c is larger than the diameter of the top surface of the cam 212 allowing the cam 212, the yolk 222, and wheel 230 to rotate 360° in both clockwise and counterclockwise directions.

In the second locked position, as shown in FIGS. 16, 17, an inner portion of the second elongated protrusion 218b is received within the second receiving groove or inside a portion of the hole or cut out 214 in cam 212 thereby limiting the rotation or swivel of the cam 212, yolk 222, and wheel 230 to the distance, if any, between the surface of the inner portion of the second elongated protrusion 218b and the edges of the hole or cut out 214. The distance may be deliberately set to limit axial rotation of the cam 212, yolk 222, and wheel 230 to a specified range. By way of example, the distance may be set such that the cam 212, yolk 222, and wheel 230 can rotate only 30 degrees. In the preferred embodiments this distance would be set to prevent axial rotation.

In alternative embodiments, the distance may be set to allow 1 to 270 degrees of axial rotation. When in the first locked position or second locked position, at least a portion of the first elongated protrusion 218a or second elongated protrusion 218b, respectively, of the sliding member 218 is aligned with and received in the one or more holes or cut outs 214 of the cam 212 limiting the rotational movement of the cam 212 and the wheel 230. By way of example, the distance may be set such that the cam 212, yolk 222, and wheel 230 can rotate only 30 degrees. In the preferred embodiments this distance would be set to prevent axial rotation. In alternative embodiments, the distance may be set to allow 0 to 10 degrees of axial rotation, 0 to 30 degrees of axial rotation, 0 to 45 degrees of axial rotation, 0 to 60 degrees of axial rotation, 0 to 270 degrees of axial rotation or any degree of axial rotation that is unreceivable to the user.

When in the unlocked position, the cam 212 is received within the channel 218c of the sliding member 218 and neither the first elongated protrusion 218a or second elongated protrusion 218b is aligned with the one or more holes or cut outs 214 of the cam 212 allowing the cam 212, the yolk, and wheel 230 to rotate 360° in a clockwise or counterclockwise direction.

The swivel assembly 208 may further include a cover plate 221 located within the top mounting plate 206 over the sliding member 218 for securing the sliding member 218 within the swivel assembly 208. The cover plate 221 includes a plurality of holes 219 for coupling or securing the cover plate 221 to the top mounting plate 206 with fasteners, for example. Fasteners, such as threaded screws pass through the plurality of holes 219 and thread into the top mounting plate 206 securing the cover plate 221 to the top mounting plate 206.

While the foregoing disclosure shows illustrative aspects, it should be noted that various changes and modifications could be made herein without departing from the scope of the disclosure as defined by the appended claims. The functions, steps and/or actions of the method claims in accordance with the aspects described herein need not be performed in any particular order. Furthermore, although elements of aspects disclosed herein may be described or claimed in the singular, the plural is contemplated unless limitation to the singular is explicitly stated.

Aspects described in connection with a given description, illustration, representation, or method may be substituted for aspects described in a different description, illustration, representation, or method.

The previous description of the disclosed embodiments is provided to enable any person skilled in the art to make or use the aspects described herein. Various modifications to these embodiments will be readily apparent to those skilled in the art, and the generic principles defined herein may be applied to other embodiments without departing from the spirit or scope of the invention. Thus, the disclosure is not intended to be limited to the embodiments shown herein but is to be accorded the widest scope consistent with the principles and novel aspects disclosed herein.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification.

1-20. (canceled)

21. A caster assembly comprising:
a mounting base attachable to a movable device;
a swivel assembly located within the mounting base, the swivel assembly comprising:
a cam having a first cutout and a second cutout;
a locking mechanism having a sliding member configured to limit a rotation range of the cam by selectively engaging one of the first cutout or the second cutout, wherein a respective width of the first cutout corresponds to a first rotation range of the cam and a respective width of the second cutout corresponds to a second rotation range of the cam; and
a yoke operably coupled to the cam, the yoke comprising a central section and two arms extending from opposite ends of the central section; and
a wheel mounted between the two arms of the yoke.

22. The caster assembly of claim 21, wherein the sliding member comprises a main body having a support arm integrally connected to, and extending from, the main body, the main body and the support arm located within a common horizontal plane.

23. The caster assembly of claim 22, wherein the first rotation range of the cam is limited by a distance between the support arm and respective edges of the first cutout.

24. The caster assembly of claim 22, wherein the second rotation range of the cam is limited by a distance between the support arm and respective edges of the second cutout.

25. The caster assembly of claim 21, wherein the sliding member comprises a first elongated protrusion and a second elongated protrusion integrally connect to, and separated by, a channel.

26. The caster assembly of claim 25, wherein the sliding member is configured to transition between:
a first locked position, in which the first elongated protrusion engages the first cutout, such that rotation of the cam is limited to the first rotation range;
a second locked position, in which the second elongated protrusion engages the second cutout, such that rotation of the cam is limited to the second rotation range; and
an unlocked position, in which the sliding member is disengaged from first cutout and the second cutout, such that rotation of the cam is not limited.

27. The caster assembly of claim 21, wherein the first rotation range is less than the second rotation range.

28. The caster assembly of claim 27, wherein the first rotation range is 0 degrees.

29. The caster assembly of claim 21, wherein the locking mechanism includes a ball detent mechanism that selectively inhibits axial movement of the sliding member.

30. A caster assembly comprising:
a mounting base attachable to a movable device;
a swivel assembly located within the mounting base, the swivel assembly comprising:
a cam having one or more cutouts;
a locking mechanism having a sliding member configured to limit a rotation range of the cam by selectively engaging each the one or more cutouts, wherein a respective width of each of the one or more cutouts corresponds to a respective unique rotation range of the cam; and
a yoke operably coupled to the cam, the yoke comprising a central section and two arms extending from opposite ends of the central section; and
a wheel mounted between the two arms of the yoke.

31. The caster assembly of claim 30, wherein the one or more cutouts includes a rectangular cutout.

32. The caster assembly of claim 31, wherein the sliding member comprises a main body having a support arm integrally connected to, and extending from, the main body, and
wherein the rectangular cutout is configured to receive the support arm such that, when the sliding member engages the rectangular cutout.

33. The caster assembly of claim 30, wherein the one or more cutouts include a first cutout and a second cutout.

34. The caster assembly of claim 33, wherein the sliding member comprises a first elongated protrusion and a second elongated protrusion integrally connect to, and separated by, a channel; and
wherein the sliding member is configured to transition between:
a first locked position, in which the first elongated protrusion engages the first cutout, such that rotation of the cam is limited to a first rotation range;
a second locked position, in which the second elongated protrusion engages the second cutout, such that rotation of the cam is limited to a second rotation range; and
an unlocked position, in which the sliding member is disengaged from first cutout and the second cutout, such that rotation of the cam is not limited.

35. The caster assembly of claim 34, wherein the first rotation range is less than the second rotation range.

36. A caster assembly comprising:
a mounting base attachable to a movable device;
a swivel assembly located within the mounting base, the swivel assembly comprising:
a cam having one or more cutouts; and
a locking mechanism having a sliding member configured to limit a rotation range of the cam by selectively engaging one of the one or more cutouts, the sliding member operable between a first locked position, a second locked position, and an unlocked position; and
a yoke operably coupled to the cam, the yoke comprising a central section and two arms extending from opposite ends of the central section; and
a wheel mounted between the two arms of the yoke.

37. The caster assembly of claim 36, wherein the one or more cutouts include a first cutout and second cutout; and
wherein the first locked position corresponds to the sliding member engaging the first cutout such that rotation of the cam is limited to a first rotation range, the second locked position corresponds to the sliding member engaging the second cutout such that rotation of the cam is limited by a second rotation range, and the unlocked position corresponds to the sliding member being disengaged such that rotation of the cam is not limited.

38. The caster assembly of claim 37, wherein a respective width of the first cutout corresponds to the first rotation range of the cam and a respective width of the second cutout corresponds to the second rotation range of the cam.

39. The caster assembly of claim 37, wherein the first cutout is a rectangular cutout; and
wherein the second cutout is an annular sector cutout.

40. The caster assembly of claim 37, wherein the first rotation range is less than the second rotation range.
